(19) United States
(12) Patent Application Publication
(10) Pub. No.: US 2008/0032569 A1
(43) Pub. Date: Feb. 7, 2008

(54) Method for Producing a Welded Joint Between Electrical Wires with a Support and Welded Joint

(75) Inventors: Ernst Steiner, Heuchelheim (DE); Dieter Stroh, Wettenberg (DE); Enno Thoms, Heuchelheim (DE)

Correspondence Address: DENNISON, SCHULTZ & MACDONALD, 1727 KING STREET, SUITE 105, ALEXANDRIA, VA, 22314, US

(73) Assignee: SCHUNK ULTRASCHALLTECHNIK GMBH, Wettenberg (DE)

(21) Appl. No.: 11/572,504

(22) PCT Filed: Jul. 20, 2005
(86) PCT No.: PCT/EP05/07919

§ 371 Date: Apr. 4, 2007

(30) Foreign Application Priority Data
Sep. 15, 2004 (DE) 10 2004 044 480.3
Jul. 23, 2004 (DE) 10 2004 035 953.9
Feb. 16, 2005 (DE) 10 2005 007 161.9

(51) Int. Cl. H01R 4/02; B23K 20/10; H01R 9/03

(52) U.S. Cl. 439/874; 228/110.1; 439/656

(57) ABSTRACT

A method and an array for ultrasound welding of litz wires with a preferably rectangular support, which are jointly inserted in a compression space, the width of which is set to match that of the support.

The present invention relates to a method for producing a welded joint between electric conductors like litz wires with a flat rigid support like an electric attachment accessory or a section thereof, in particular the section of an earthing contact, contact blade or cable shoe, whereby the conductor is welded with the support in a compression space of preferentially rectangular cross section bounded by four bounding surfaces, where the cross section of said compression space is diminished on welding, whereby a first bounding surface is formed by a first electrode like a sonotrode, a second bounding surface that extends parallel or approximately parallel to the first bounding surface is formed by a counter electrode like an anvil, which is shiftable with respect to the first electrode, and remaining third and fourth bounding surfaces are formed by a first and a second bounding element, which are shifted in relation to the first electrode. The present invention further relates to a welded connection particularly produced by ultrasound or resistance welding and consisting of a support like a section of an electric attachment accessory, in particular in the form of an earthing contact, contact blade or cable shoe and conductors welded with the support.

From DE-A-199 06 088 a method is known, whereby a battery terminal connector is welded with a contact piece, which in top view discloses a trapezoid geometry in the weld area. The contact piece and battery terminal connector cable are introduced into a compression space of an ultrasound welding device that is adjustable in height and width. The lateral slides that form the lateral boundaries are each shiftable in the direction of the contact piece and must fit into the oblique lateral sides of the contact piece so that the compression space may be closed. For this purpose, an anvil may additionally be dipped into the compression space.

In order to weld litz wires onto a support by means of ultrasound, DE-C-34 37 749 provides jaws that bound a compression space laterally and are shiftable along the support, whereby the clearance of the jaw is adjusted to the width of a section of a radial sonotrode to be dipped into the compression space.

From DE.Z. (magazine): Die Bibliothek der Technik, Vol. 108: Ultraschall-Metallschweiβen (Ultrasound metal welding), published by Moderne Industrie, 86895 Landsberg, 1995, page 43, a method is known for welding a cable shoe having a U-shaped cross section with electric conductors by means of ultrasound. For this purpose, ultrasound welding devices are known, where the cable shoe is supported by a counter electrode. Bounding elements are arranged shiftable on the side of the cable shoe and extending along the lateral sides, between which a sonotrode, i.e. the head of the sonotrode with the welding surface, can be lowered in the direction of the counter electrode in order to weld the conductor with the cable shoe. So as to ensure the shifting capacity of the sonotrode, and take tolerances of the cable shoe into account, the lateral boundaries run along the external surfaces of the lateral sides at a small distance. Thereby, cross forces arising during welding may cause the lateral sides to be bent apart.

It is further disadvantageous in the known arrangement that the filling volume is determined by the height of the lateral side of the cable shoe, whereby the cable shoe may only be filled with litz wires to be welded in a way that no litz wire may be pressed out of the cable shoe on lowering the sonotrode.

Specially developed ultrasound welding devices are required for the method described above for the mechanical and electrical connection of electric conductors like litz wires with an electrical attachment accessory having a flat or U-shaped support. These ultrasound welding devices are not suitable for the production of transit or end nodes of litz wires. This problem particularly appears on final assembly of a customized wiring harness clamped into an assembly jig, where different wire combinations as well as attachment accessories with different flat supports are used. In prior art methods such requirements can only be fulfilled with expensive and time-consuming tool changes.

Ultrasound welding devices having compression space that is adjustable in height and width are known from EP-B-0 143 936 or DE-A-37 19 083.

The object of the present invention is to further develop a method of the type described at the beginning so that welded connections of the type described at the beginning may be produced cost-effectively maintaining high performance.

According to the present invention, the object is basically attained in that a support is used that has parallel or approximately parallel lengthwise side edges, in that thereby the compression space is modified in its cross-section, in that the first bounding element with a gap is shifted along the first bounding surface in the direction of the second bounding element configured as a mounting of the counter electrode, which in turn is shifted, maintaining a gap, only vertically or approximately vertically with respect to the first bounding surface, in that the conductors and support are introduced into the open compression space bounded by the first bounding surface, by the third bounding surface running within the effective range of the first bounding surface and by the fourth bounding surface, in that the first bounding element is shifted in the direction of the second bounding element so that the distance of the third and fourth bounding surfaces is adjusted for clearance between the lengthwise side edges of the support, and in that consequently the counter electrode is shifted in the direction of the first electrode by shifting the second bounding element.

In contrast to the prior art, the entire unit that has a cuboid geometry consisting of flat, supports basically rectangular in their cross-section and electric conductors extends into the compression space. Thus, compressing and welding is possible using prior art ultrasound welding devices, which thus far have been used only for welding transit and end nodes. Thereby no tool change is necessary on final assembly of a customized wiring harness with different wire combinations as well as attachment accessories with different flat supports of diverse cross-sections. The adjustment of the compression space to the unit formed by the support and the electric conductors is infinitely variable.

A level flat or bent flat element may be used as a support. The litz wire may be introduced precompressed or non-precompressed into the compression space. The former is advantageous if the litz wires are to be welded in the desired position on the support or have a small overall cross section.

The adjustment of the clearance between the third and fourth bounding surfaces, i.e. the bounding elements and consequently the width of the compression space, particularly ensures that the litz wires are welded with the support in the required area without the risk of litz wires being pressed out laterally. Thereby, the litz wires may be accommodated uneventfully, because the base area of the compression space, whereon the litz wires are accommodated, is closed around its perimeter, i.e. virtually forming a groove-shaped or canal-shaped attachment on removed or largely removed counter electrodes, and is freely accessible.

In order to facilitate an especially firm welded connection and simultaneously ensure that undesired heating does not occur during the passage of current, an arrangement of the present invention that should be emphasized is that conductors with an overall cross section are accommodated in the compression space, that the cross section of the conductors that are compressed and welded with the support is the same or approximately the same as the cross section of the support.

Another remarkable feature of the present invention is that the conductors are accommodated on the first bounding surface in the open compression space and thereafter are placed on the conductors of the support, and that subsequently the first bounding element that is shiftable along the first bounding surface is either approached on the facing lengthwise side edge of the support, whereby the opposite lengthwise side edge of the support abuts the fourth bounding surface, or shifted up to a distance between the third and fourth bounding surface, which is the same as or slightly smaller than the clearance between the lengthwise side edges of the support.

The present invention particularly features the following method steps:
accommodation of the conductors to be welded on the first electrode with open compression space,
accommodation of the support of basically rectangular cross section Q_{T} on the conductors,
shifting of the first bounding element in the direction of the second bounding element up to a distance b between the third and fourth bounding surfaces, whereby the distance b is adjusted to the clearance between the lengthwise side edges of the support,
compacting the conductors between the support and the first electrode by lowering the counter electrode onto the support and force impingement of the support in the direction of the first electrode,
determination of the height or width or at least one other characteristic dimension of the compression space after compacting is concluded,
retrieving stored welding parameters on the basis of the height or width and/or the characteristic dimension of the compression space,
welding the compacted conductors with the support and simultaneous change in spacing between the first electrode and the second electrode,
opening the compression space by lifting the second electrode and distancing the first bounding element from the second bounding element, and
removal of the welded joint, which was produced by the conductor welded with the support, from the compression space.

A further preferred procedure provides that the welding parameters are determined and/or selected as a function of the cross-section Q_{T} of the flat support and the cross section Q_{L} of the electric conductors.

The above method permits the use of an attachment accessory with a simple flat support and/or terminal. These are more cost-effective as compared with the applied prior art attachment accessories having a U-shaped support because no bending procedures are required with consequently less waste.

With the use of an attachment accessory with a flat support, the twisting of lateral sides as it occurs with prior art U-shaped supports, is not possible either. As the lateral bounding surfaces abut closely on the facing lateral surfaces of the flat support, the possibility that isolated litz wires of the conductors are not included during welding is additionally ruled out.

Further, it is not necessary that flat supports disclose a special geometry, like a V geometry. On the contrary, the support according to the present invention has a flat cuboid geometry, i.e. a rectangular geometry from a top view.

In order also to provide the possibility of firmly connecting conductors like litz wires having a small overall cross-section as compared with the area of the support and terminals, a self-inventive scheme proposes that the electric conductors like litz wires are welded with the support as a precompacted and/or prewelded unit. Thereby, particular provision is made that the precompacted and/or prewelded and/or welded unit with a preferentially rectangular cross section are introduced into the compression space, then positioned on the supporting element, and subsequently welded with the support by the relative movement of the first electrode toward the counter electrode and vibratory excitation of the first electrode.

By welding the litz wires in the first sequence, the conductors may be welded on desired positions of the support and/or conductors having a small overall cross section may be welded to the support, whereby these may disclose a U-geometry if required. Thereby the lateral sides extending along the litz wire structure disclose a length that is greater than the height of still not welded litz wires between the sides, whereby prior art welding would not be possible.

On the basis of the teachings of the present invention, the litz wires are first welded to form a litz wire structure having a height that overtops the lateral sides.

The present invention further relates to a welded connection, in particular to a welded connection produced by ultrasound or resistance welding, consisting of a support like a section of an electric attachment accessory in particular in the form of an earthing contact, contact blade or cable shoe, and with conductors welded with the support, and is characterized in that the welded connection features a cuboid shape that consists of the support having a cross section Q_{T} with the conductors welded with said support presenting an overall cross-section Q_{L}, whereby said overall cross-section Q_{L} of the welded conductors is similar or approximately similar to the cross-section Q_{T} of the support, with the cross section of the support amounting preferentially to between 0.5 mm² and 100 mm², and the cross section of the welded conductors correspondingly in the same range.

Other objects, advantages and characteristics of the present invention not only become apparent from the Claims, the features disclosed therein—by themselves and/or in combination—but also from the following description of a preferred exemplary embodiment taken from the drawings.

The drawings show:

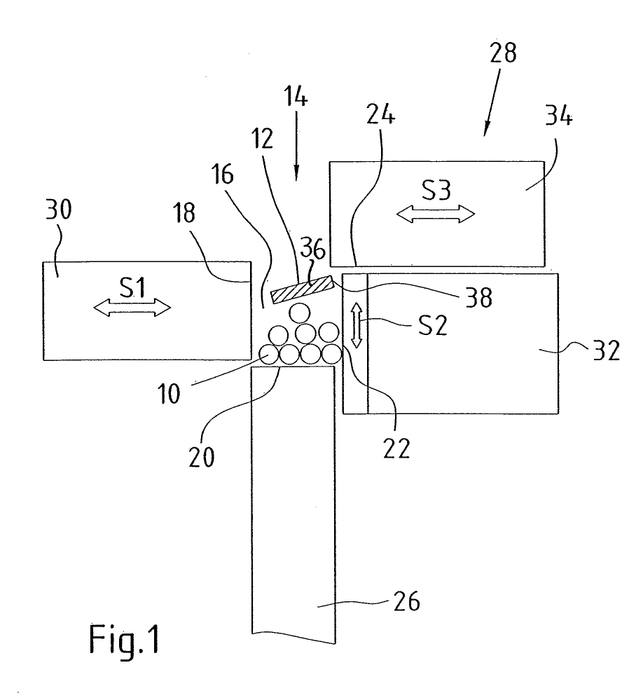

FIG. 1 a compression space of modifiable cross section of an ultrasound welding device in a first position,

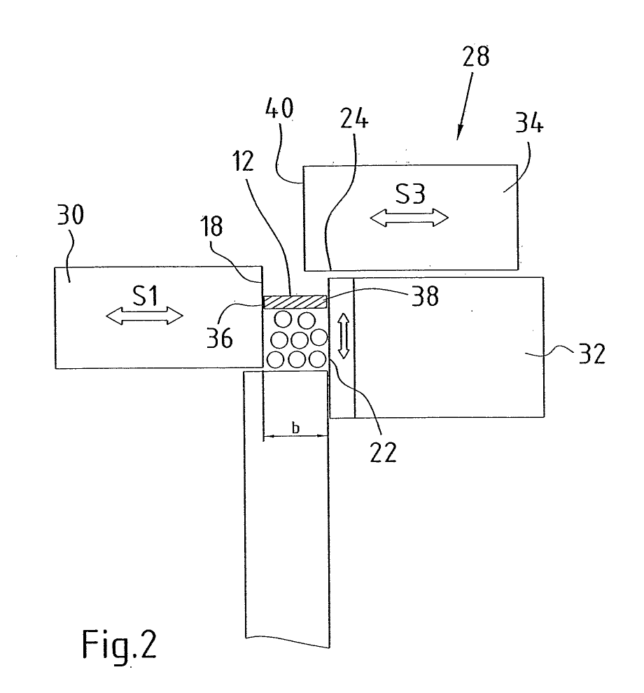

FIG. 2 the compression space according to FIG. 1 in a second position,

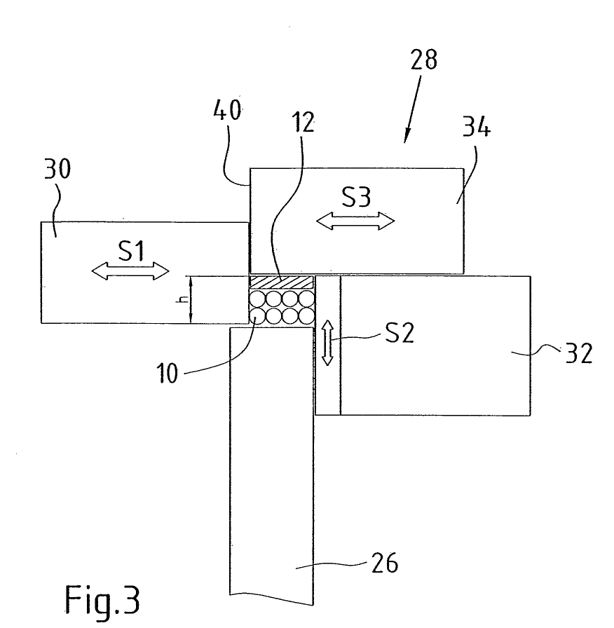

FIG. 3 the compression space according to FIGS. 1 and 2 in a third position,

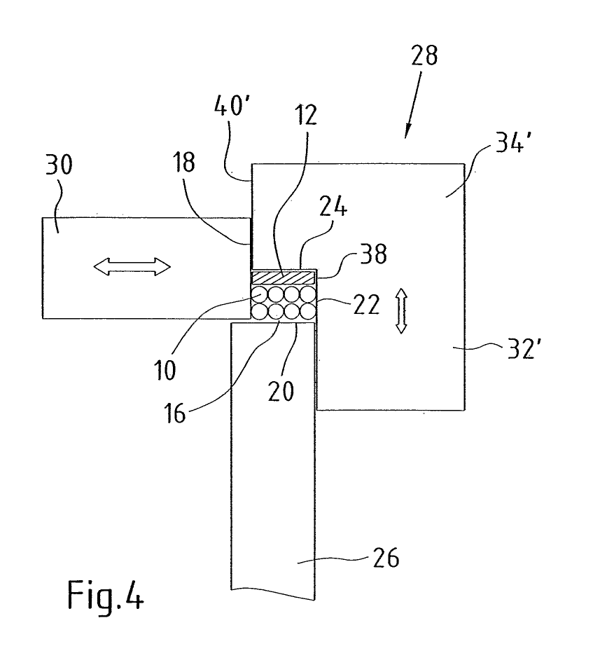

FIG. 4 another embodiment of a compression space of modifiable cross section of an ultrasound welding device,

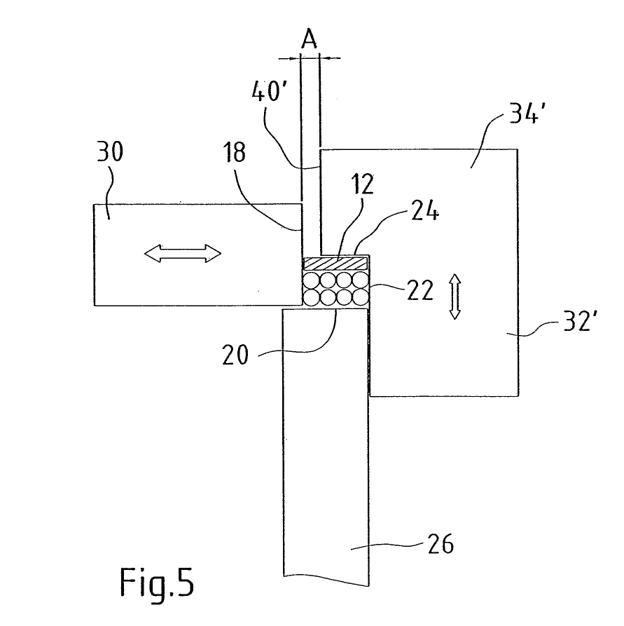

FIG. 5 another embodiment of a compression space of modifiable cross section of an ultrasound welding device,

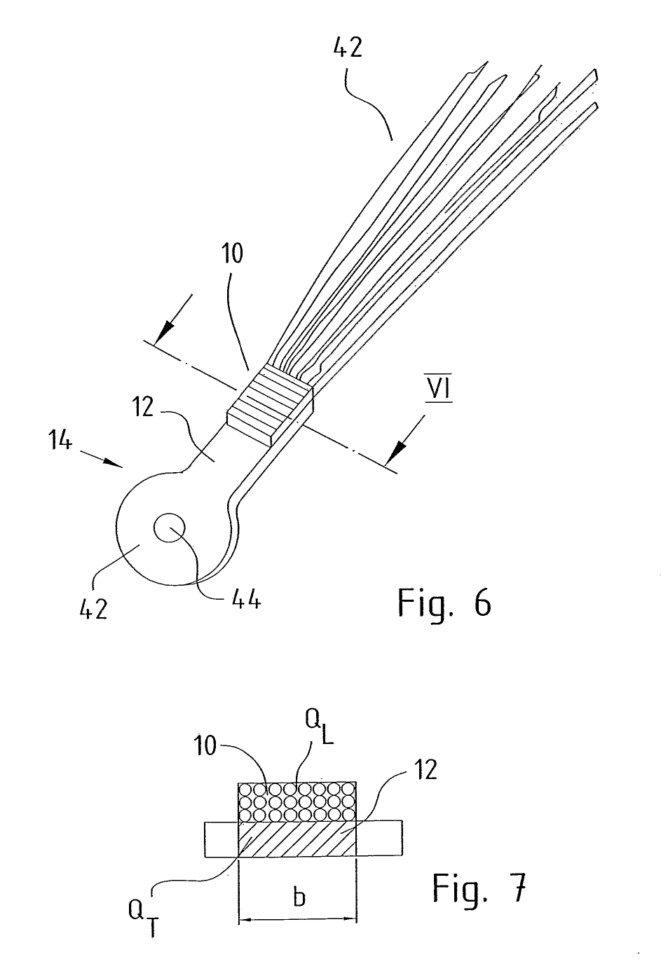

FIG. 6 an electric attachment accessory with welded litz wires in a perspective view,

FIG. 7 a section along the line VI-VI in FIG. 6,

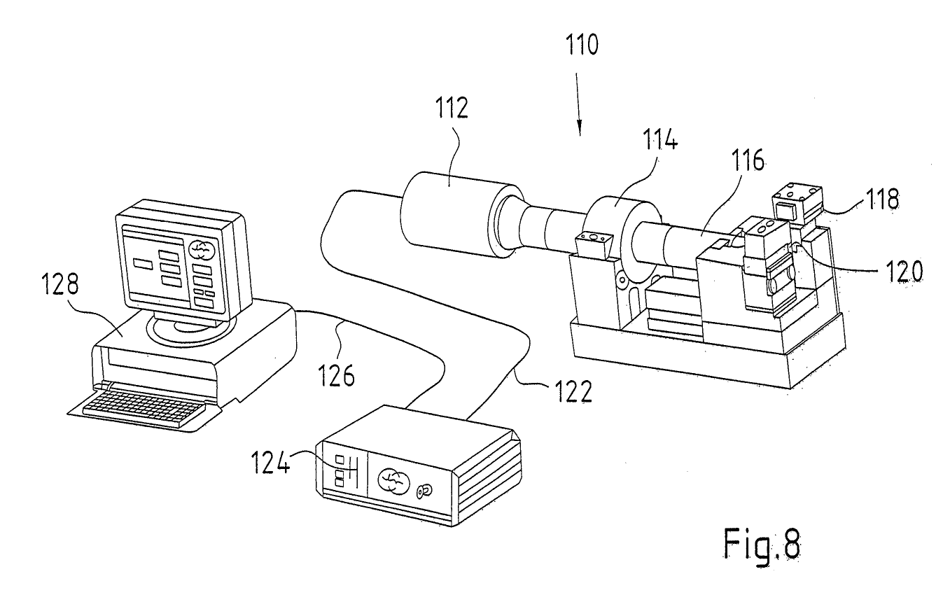

FIG. 8 a schematic diagram of an ultrasound welding arrangement,

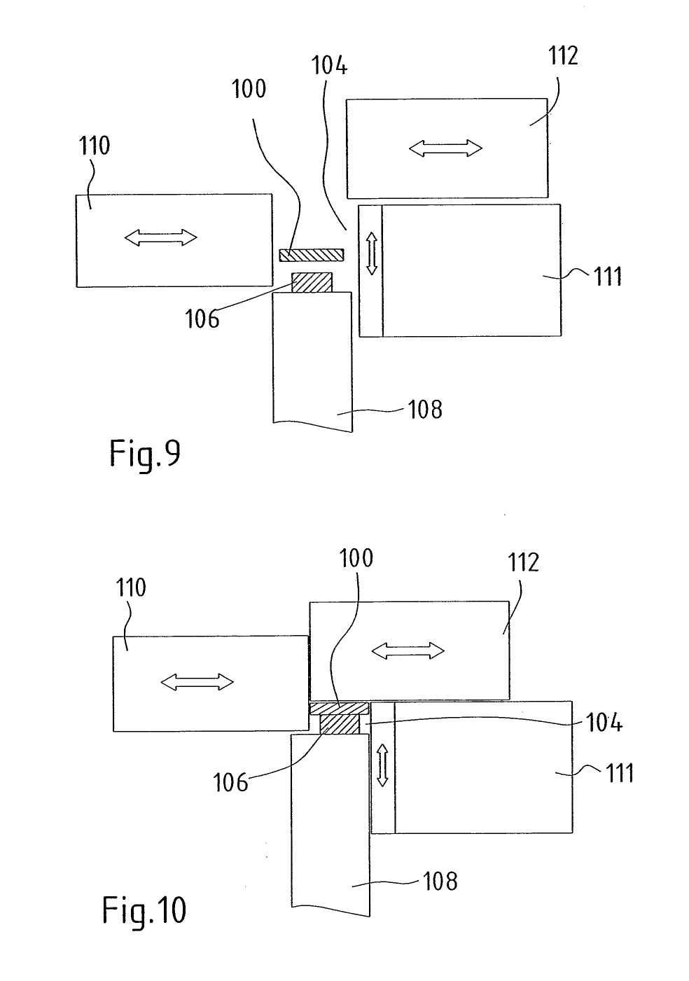

FIG. 9 a schematic diagram of an arrangement of litz wire structure and support prior to welding,

FIG. 10 the arrangement according to FIG. 9 during welding,

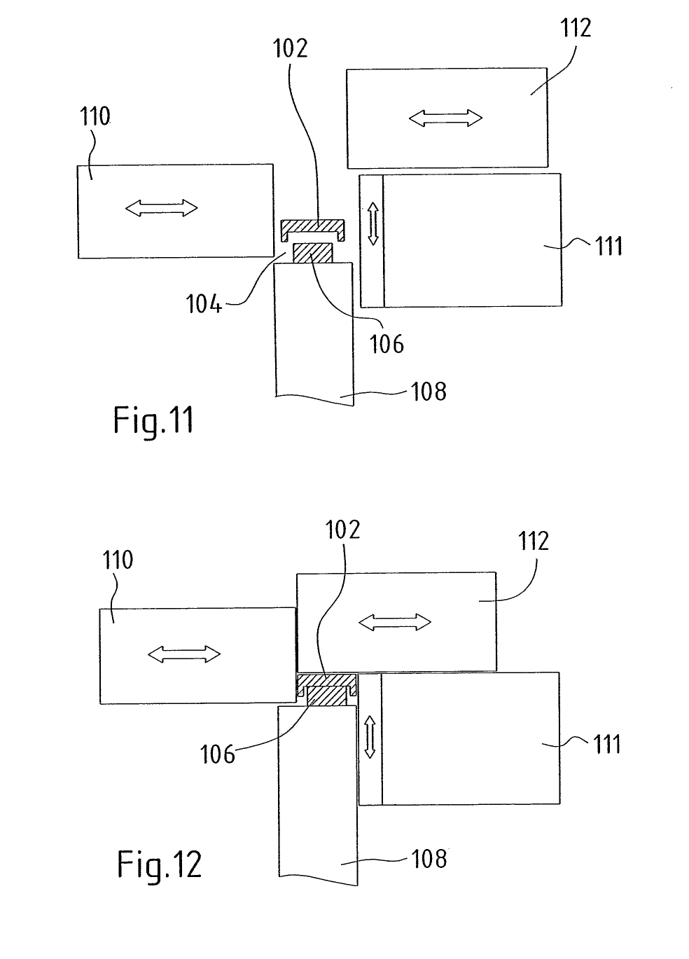

FIG. 11 a diagram matching FIG. 9 with a differently arranged support and

FIG. 12 a diagram matching FIG. 10.

In FIG. 8 an arrangement is illustrated purely on principle, with which electric conductors are ultrasound welded with a rigid flat support. The arrangement comprises an ultrasound welding device or machine 110, which usually comprises a converter 112, or if required a booster 114 as well as a sonotrode 16. A multipiece counter electrode 118—also designated as anvil—as well as a slide 120 are attached to the sonotrode 116 and/or a surface thereof, as may be seen in DE-C-37 19 083, the disclosure of which is expressly made reference to. The sonotrode 116 and/or the surfaces thereof, the counter electrode 118 as well as the slide 120 confine a cross sectionally shiftable compression space, which is illustrated in greater detail in FIG. 1-5. The elements to be welded are introduced into the compression space.

The converter 112 is connected to a generator 124 via a cable 122, which in turn leads to a PC 128 via a cable 126, from where the welding process is controlled and into which welding parameters and/or cross section and/or width of the support as well as those of the conductors to be welded with it are entered, and/or stored values are retrieved.

FIG. 1 shows a detail of an ultrasound welding device in principle illustrated in FIG. 8 as far as compression space is concerned. A mechanical and electrical conducting joint of electric conductors 10 like litz wires, which must not be previously crimped, with a rigid flat support 12 having a cross section Q_{T} is produced by means of the ultrasound welding device, which may be the section of an attachment accessory 14 like an earthing contact or cable shoe. For this purpose, the conductors 10 and the support 12 are introduced into a compression space 16.

The compression space 16 has—in cross section as well as longitudinal section—a rectangular geometry and is open on the front end to lead the cable of litz wires out.

The compression space comprises a first bounding surface 20, which consists of a section of a sonotrode 26. A second bounding surface 24 extends opposite the surface 18, and consists of a crosshead acting as a counter electrode or anvil 34, which in the exemplary embodiment of FIG. 1 to 3 originates in a bounding element 32.

The compression space 16 is confined laterally by a bounding element designated as a slide 30, which forms a third bounding surface 18 running vertically with respect to the first bounding surface 20 and second bounding surface 24. The opposite fourth bounding surface 22 consists of the first bounding element 32 that may only be shifted vertically or approximately vertically with respect to the bounding surface 18, and which may also be designated as a second bounding element. The second bounding element 32 and the crosshead 34 consequently form a multipiece counter electrode as may be seen in the prior art, e.g. in the form of DE-C-35 08 122, the disclosure of which is expressly made reference to.

The direction of motion of the slide 30, the bounding element 32 and the anvil 34 is symbolized by the double arrows S1, S2 and S3.

The conductors 10 to be welded with the support 12 are accommodated in the compression space 16. The compression space 16 is open in the process. For this purpose, the anvil 34 and/or the crosshead appears shifted to the right in the drawing, so that the compression space 16 is accessible from above, however, without letting the litz wires 10 slide laterally out of the compression space 16; because the bounding surface 18 of the slide 30 is located within the effective range of the bounding surface 18 of the sonotrode 26.

According to the present invention, the conductors 10 are welded with the support 12 in the compression space 16 that is preferentially infinitely shiftable in cross section, whereby said compression space 16 is adjustable in its width, i.e. in the distance between the third and fourth bounding surfaces 18, 22 with respect to the width of the support 12, i.e. the clearance of its lengthwise side edges 36, 38. Thereby the slide 30 is shifted toward the second bounding element 32 supporting the crosshead 34 (counter electrode). Consequently, only the slide 30 is shifted parallel toward the first bounding surface 20, whereas the second bounding element 32 is moved vertically with respect to it, namely to lower and/or lift the crosshead 34.

According to the preferred procedure, the conductors 10 to be welded are first accommodated in the compression space 16, i.e. are positioned on the first bounding surface 20. Afterwards, the support 12 is introduced, whereby its flat area extends along the first bounding surface 20, i.e. approximately vertically with respect to the third and fourth bounding surfaces 18, 22. The lateral slide 30 is then moved in the direction of the second bounding element 32 in the direction of the arrow S1, so that the distance between the third and fourth bounding surfaces 18, 22 is the same as or slightly smaller than the clearance between the lengthwise side edges 36, 38 of the support 12. This can be carried out automatically or also by shifting the support 12 in the direction of the second bounding element 32 on movement of the slide 30, so that the support 12 is virtually engaged by the bounding surfaces 18 and 22, with their distance corresponding with the clearance of the lengthwise side edges 36, 38 of the support 12. Then, the second bounding element 32 is shifted along the sonotrode 26 (arrow S2). Simultaneously, the crosshead or anvil 34 is shifted in the direction of the third bounding surface 18, so that the compression space 16 closes, as shown in FIG. 3.

The width b of the compression space is either limited by a mechanical stop according to the specified width of the support 12 or by said support 12 itself. Consequently, the width b of the compression space 16 is basically determined as a function of the width of the support 12.

After the compression space 16 is closed, the bounding element 32 and thereby the anvil 34 are shifted in the direction of the sonotrode 26. This can be carried out pneumatically, for example. Thereby the conductors 10 are compressed. After the compression is completed, the compression space 16 presents a height h. The height h can be determined by means of a displacement transducer attached to the second bounding element 32, in order to subsequently retrieve previously filed welding parameters like welding energy, welding amplitude, welding time and welding pressure, taking the height or another characteristic magnitude of the compression space 16 as a basis, in order to weld the conductors 10 with the support 12 by means of ultrasonic excitation of the sonotrode 26 and force impingement on the conductors 10 and support 12 via the anvil 34, with a simultaneous diminution of the height h. After the welding process is concluded, the anvil 34 is retracted (lifted). According to the drawings, the slide 30 is moved to the left.

Subsequently, the welded connection consisting of the conductors 10 and the support 12 can be withdrawn from the compression space 16.

The cross section of the conductors 10 accommodated in the compression space 16 should be disposed so that the overall cross section of the conductors welded with the support 12 corresponds to or approximately corresponds to the cross section of said support 12.

FIGS. 4 and 5 illustrate further embodiments of compression spaces of ultrasound welding devices in order to weld the conductors 10 with a rigid flat support 12 according to the teachings of the present invention.

In contrast to the exemplary embodiment of FIGS. 1 and 3, in FIGS. 4 and 5 the anvil 34′ and the second bounding element 32′ are disclosed in one piece. Thereby the section of the anvil 34′ protruding in the direction of the slide 30 is based on the width of the compression space 16 to be adjusted, i.e. the clearance of the lengthwise side edges 36, 38 of the support 12. The welding procedure for welding the conductors 10 with the support 12 is carried out as described above.

The method according to the present invention is also feasible if, as observable in FIG. 5, the area of the anvil 34′ protruding along the sonotrode 26 is smaller than the clearance of the lengthwise side edges 36, 38 of the support 12. In any case, the protruding section of the anvil 34′ that forms a unit with the second bounding element 32′ should have a magnitude that ensures that on welding the conductors 10 with the support 12, the latter cannot overturn into the compression space 16.

FIG. 6 displays a perspective view of the attachment accessory 14 having a flat support 12, to which the conductors 10 of electric cables 42 are welded.

FIG. 7, which displays a cross section along the section line VI according to FIG. 6, shows the cross section of the welded connection, in particular ultrasound or resistance welded connection, basically arranged rectangular-shaped, whereby the width of the cross section is specified and/or determined by the width b of the support 12.

The attachment accessory 14 is preferentially arranged as a flat punch accessory made of a conductive metal like copper, whereby the flat support 12 has a cross section Q_{T} so that it basically corresponds to the cross section Q_{L} of the compacted conductors 10. The method according to the present invention may be used in attachment accessories with isolation crimp as well as in attachment accessories without isolation crimp.

If an attachment accessory 14 without isolation crimp is used, the transition point between the flat support 12 and the cables 42 may be insulated and sealed by means of shrink tubing. The shrink tube serves as insulation, and, if required, waterproof isolation, and may additionally absorb cross and longitudinal forces optimally. The shrink tube may also be filled with a filling material like hot-melt adhesives.

The welded connection may also be fastened by means of a wire strap embracing the support.

Compared with the prior art, the method according to the present invention is particularly characterized in that simple and flat attachment accessories may be used for contacting, which are cost-effective to produce, as no bending operations are required and consequently less waste is generated, as it used to occur with prior art U-shaped attachment clips. The provision of a terminal lug 42 with bore 44 of the attachment accessory 14, partially coated with tin for example, is also possible.

Compared with the prior art, the cross section Q_{T} of the flat section 12 of the attachment accessory is enlarged in order to achieve mechanical stability on the one hand and good electrical conductivity on the other hand. Reinforcement ribs may also be provided in the transition point between the flat support 12 and the terminal lug 42.

A particular advantage that should be emphasized, however, is that the described method is possible with standard litz wire welding machines, used in the prior art to produce transit and end nodes. Thus, it may also be used without the need of a tool change on final assembly of customized wiring harnesses, for example, where different wire combinations as well as different connection widths of flat supports are used.

FIG. 9 to 12 display a self-inventive suggestion for welding conductors like litz wires with a contact piece (support). Thereby, in contrast to the previously described exemplary embodiments, a contact piece 100, 102 is not welded with loose litz wires to be introduced into the compression space 104 of an ultrasound welding device, but with a compressed and/or welded litz wire structure 106, which in section has a rectangular shape in the exemplary embodiment. This procedure results in the advantage that litz wires with a relatively small overall cross section may also be welded with a large-surface support and/or onto a desired position of the support, without having to assume losses regarding contacting and connection stability.

Therefore, FIG. 9 shows that the litz wires compressed and/or welded to form a unit are first introduced into the compression space 104, which is bounded in the usual way by a sonotrode 108, a lateral slide 110, a support 111, an anvil 112 and the litz wires themselves. Thereby the compression space 104 is open in the first instance, so that in the exemplary embodiment the anvil 112 on the support 111 is shifted to the right. After the litz wire structure 106 has been positioned on the sonotrode 108 and the contact piece 100 has been introduced into the compression space 104, the lateral slide 110 is shifted in the direction of the support 111, so that the clearance between the corresponding bounding surfaces of the lateral slide 110 and the support 111 is the same or approximately the same as the clearance of the lengthwise side edges of the contact piece 100. Subsequently the support 111 is shifted together with the anvil 112 in the direction of the sonotrode 108. With this, the anvil 112 has been first shifted in the direction of the lateral slide 110 and is moved along its lateral surface bounding the compression space 104. The closed position of the compression space 104 during welding of the contact piece 100 with the litz wires and/or litz wire structure 106 is displayed in FIG. 10.

The embodiment illustrated in FIGS. 11 and 12 corresponds to that in FIGS. 9 and 10 in principle, so that the same reference signs are used for the same elements.

In contrast to the illustrations in FIGS. 9 and 10, the contact piece 100 does not disclose a plate or disc shape, i.e. a rectangular geometry in section, but is arranged—as is frequently the case with terminals—U-shaped. Notwithstanding, according to the inventive teachings, it is by all means possible to weld the contact piece 102 with litz wires having a small cross section, because the litz wires are previously compacted and/or welded to form a litz wire structure 106. This ensures that the height of the litz wire structure 106 is greater than the effective length of the lateral sides of the contact piece 102, resulting in a flawless welding of the litz wires with the contact piece 102, as is observable in FIG. 12.

1. Method for producing a welded joint between electric conductors like litz wires with a flat rigid support like an electrical attachment accessory or a section thereof, in particular a section of a earthing contact, contact blade or cable shoe, whereby the conductor is welded with the support in a compression space of preferentially rectangular cross section bounded by four bounding surfaces, where said compression space is diminished in cross section on welding, whereby a first bounding surface is formed by a first electrode like a sonotrode, a second bounding surface that is parallel or approximately parallel to the first bounding surface by a counter electrode like an anvil shiftable with respect to the first electrode, and remaining third and fourth bounding surfaces by a first and a second bounding element, which are shifted in relation to the first electrode, characterized in that a support is used that has parallel or approximately parallel lengthwise side edges, in that thereby the compression space is modified in cross section, in that the first bounding element with a gap along the first bounding surface is shifted in the direction of the second bounding element arranged as a mounting for the counter electrode, which in turn is shifted, maintaining a gap, only vertically or approximately vertically with respect to the first bounding surface, in that the conductors and support are introduced into the open compression space bounded by the first bounding surface, by the third bounding surface running within the effective range of the first bounding surface and by the fourth bounding surface, in that the first bounding element is shifted in the direction of the second bounding element so that the distance of the third and fourth bounding surfaces is adjusted for clearance between the lengthwise side edges of the support, and in that consequently the counter electrode is shifted in the direction of the first electrode by shifting the second bounding element.

2. Method according to claim 1, characterized in that a level flat or bent flat element is used as a support.

3. Method according to claim 1, characterized in that the litz wires are introduced into the open compression space non-crimped.

4. Method according to claim 1, characterized in that the conductors are placed on the first bounding surface and then on the conductors of the supports in the open compression space, and that subsequently the first bounding element shiftable along the first bounding surface is either approached from the facing lengthwise side edge of the support, whereby the opposite lengthwise side edge of the support abuts the third bounding surface, or is shifted by a distance between the third bounding surface and the fourth bounding surface, which is similar to or slightly smaller than the clearance between the lengthwise side edges of the support.

5. Method according to claim 1, characterized in that conductors with an overall cross section are introduced into the compression space, that the cross section of the conductors that are compressed and welded to the support is similar or approximately similar to the cross section of the support.

6. Method according to claim 1, characterized in that the distance between the third and the fourth bounding surface is adjusted to a predefined value, which is adjusted to the clearance of the lengthwise side edges of the support.

7. Method according to claim 1, characterized in that the distance between the third and the fourth bounding surface is adjusted to a value so that the support is movable by the introduction of force by the counter electrode in the direction of the electrode and in the direction parallel to the fourth bounding surface.

8. Method according to claim 1, characterized in that the adjustment of the compression space to the geometry resulting from the support and the electric conductors is infinitely variable.

9. Method according to claim 1, characterized in that the method includes the following steps:
accommodation of the conductors to be welded on the first electrode with open compression space,
accommodation of the support of basically rectangular cross section Q_{T} on the conductors,
shifting the first bounding element in the direction of the second bounding element up to a distance b between the third and fourth bounding surfaces, whereby the distance b is adjusted to the clearance between the lengthwise side edges of the support,
compacting the conductors between the support and the first electrode by lowering the counter electrode onto the support and force impingement in the direction of the first electrode,
determination of the height h or width b or at least one other characteristic dimension of the compression space after compacting is concluded,
retrieving stored welding parameters on the basis of the height h or width b and/or the characteristic dimension of the compression space,
welding the compacted conductors with the support and simultaneous change in spacing between the first electrode and the second electrode,
opening the compression space by lifting the second electrode and distancing the first bounding element from the second bounding element, and
removal of the welded joint, which was produced by the conductor welded with the support, from the compression space.

10. Method according to claim 1, characterized in that the welding parameters are determined and/or selected as a function of the cross section Q_{T} of the support and/or the overall cross section of the conductors.

11. Method according to claim 1, characterized in that the electric conductors as well as litz wires are welded as a precompressed and/or prewelded or welded unit with the support.

12. Method according to claim 11, characterized in that a support having a U-shaped section is used, whose lateral sides extend along the conductors, whereby the cross section of the surface extending between the lateral sides is preferentially smaller than the overall cross section of the conductors.

13. Method according to claim 11, characterized in that the conductors are introduced into the compression space as a precompressed and/or prewelded and/or welded unit of preferentially rectangular geometry, then positioned on the supporting element, and subsequently welded with the support by relative movement of the first electrode toward the counter electrode and vibratory excitation of the first electrode.

14. Ultrasound or resistance welded connection consisting of a support (12) like the section of an electric attachment accessory, in particular in the form of an earthing contact, contact blade or cable shoe, and conductors (10) welded with the support,
characterized in that the welded connection discloses a cuboid shape that consists of the support (12) with conductors (10) welded with said support and presenting an overall cross section Q_{L}, whereby said overall cross section Q_{L} of the welded conductors is similar or approximately similar to the cross section Q_{T} of the support viewed at right angle to the longitudinal direction of the conductor.

15. Welded connection according to claim 14, characterized in that the support (12) has a rectangular cross section Q_{T} measuring from 0.15 mm² to 100 mm²≦Qₜ≦100 mm².

16. Welded connection according to claim 14, characterized in that the overall cross section Q_{L} of the conductors (10) is 0.15 mm²≦Q_{L}≦100 mm².

17. Welded connection according to claim 14, characterized in that the welded connection is insulated, sealed and secured against longitudinal and cross forces by means of shrink tubing or a filling material like hot-melt adhesive.

18. Welded connection according to claim 14, characterized in that the welded connection is fastened with a wire strap that embraces the support.
